(19) United States
(12) Patent Application Publication
(10) Pub. No.: US 2012/0140370 A1
(43) Pub. Date: Jun. 7, 2012

(54) Protection Circuit and Protection Method

(76) Inventors: Ren-Yi Chen, Hsin-Chu (TW); Kuo-Chien Huang, Hsin-Chu (TW)

(21) Appl. No.: 13/311,553

(22) Filed: Dec. 6, 2011

(30) Foreign Application Priority Data
Dec. 6, 2010 (TW) 099142405

(51) Int. Cl. H02H 3/00

(52) U.S. Cl. 361/87

(57) ABSTRACT

A controller is applied with a protection circuit and a protection method. A controller detects an input signal generated by a current flowing through a detection resistor, thereby turning on or off a switch, for controlling the current. A shielding time generator provides a shielding time. When the switch is turned on and when a current timing without the shielding time, a short-circuit detector compares the input signal with a first reference voltage, thereby asserting a short-circuit detection signal. When the switch is turned off or when the current timing is during the shielding time, the short-circuit detection signal is not asserted. Each time the short-circuit detection signal is asserted, a logic controller turns off the switch, thereby reducing the current.

### BACKGROUND OF THE INVENTION

1. Field of the Invention

The present invention relates to a protection circuit for a power supply.

2. Description of the Prior Art

Requirements for high conversion efficiency and small product size lead to most conventional power supplies being switching mode power supplies (SMPS). A SMPS turns a power switch on or off to charge or discharge an inductive element, thereby fulfilling power requirements of a connected load.

Some SMPSs are required to detect current flowing through the inductive element for controlling an active time or an inactive time of the power switch. For example, FIG. 1 illustrates conventional SMPS 10 having a flyback structure. Bridge regulator 12 regulates a conventional AC power source for providing primary winding voltage V_{IN} at terminal IN, where an upper bound of primary winding voltage V_{IN} may range from one hundred to three hundred volts. At terminal CS, controller 18 retrieves detection signal V_{CS} with the aid of current detection resistor 14, where detection signal V_{CS} indicates an inductive current flowing through primary winding 28 of transformer 26 under a normal state. Controller 18 increases or reduces the inductive current by controlling whether to turn power switch 16 on or off. A voltage level at terminal LN of controller 18 is provided from primary winding voltage V_{IN} with the aid of both voltage-dividing resistors 22 and 24. When controller 18 is operated in a conventional current mode, controller 18 roughly limits peak of detection signal V_{CS} to control the active time of power switch 16, and thereby to keep load 30 at a stable power-supply state.

If current detection resistor 14 is short-circuited, detection signal V_{CS} will be roughly kept at zero volts, and controller 18 will misjudge that the inductive current of primary winding 28 fails to reach an expect peak, and thereby keep power switch 16 turned on. As a result, transformer 26 may be overheated, or even explode and burn out. US Patent Publication US 2009/0279214, which is cited as '214 application in the following, has disclosed a protection device and a protection method for neutralizing the above-mentioned short-circuit issue, however '214 application also introduces certain defects.

### SUMMARY OF THE INVENTION

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a conventional SMPS.

FIG. 2 illustrates a controller according to an embodiment of the present invention.

FIG. 3 illustrates a logic controller according to an embodiment of the present invention.

FIG. 4 illustrates waveforms of signals shown in FIG. 2.

### DETAILED DESCRIPTION

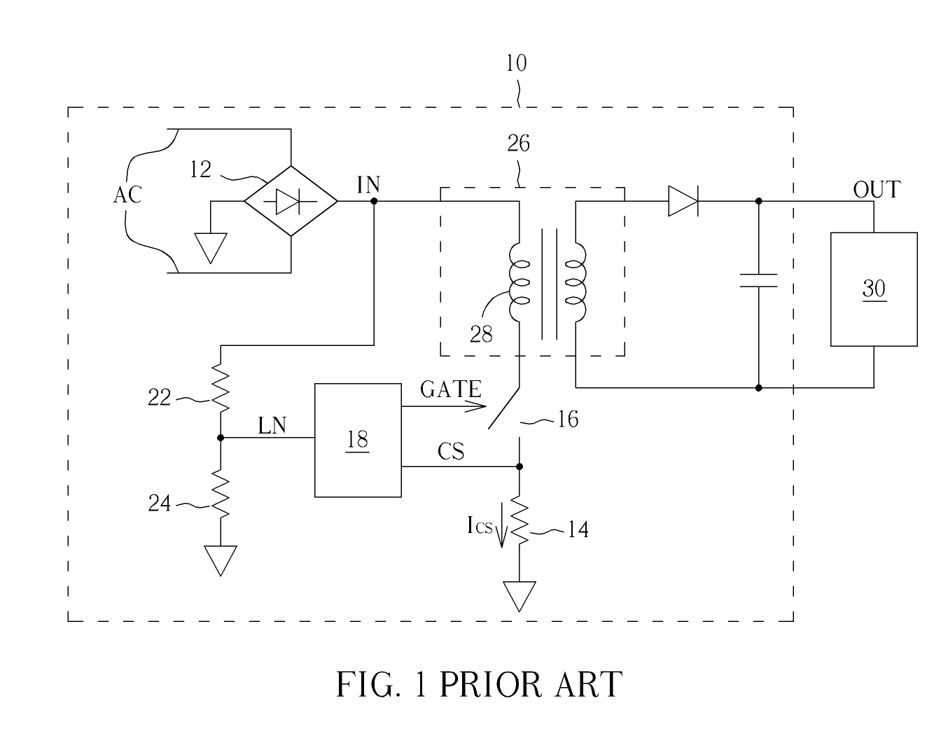

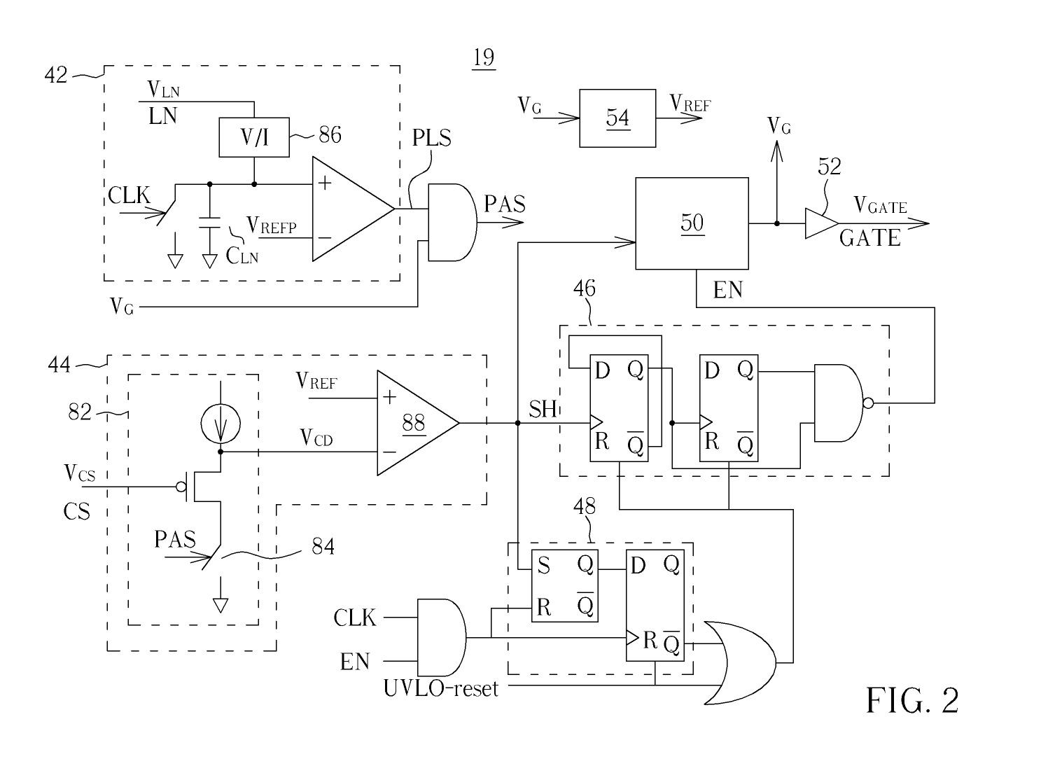

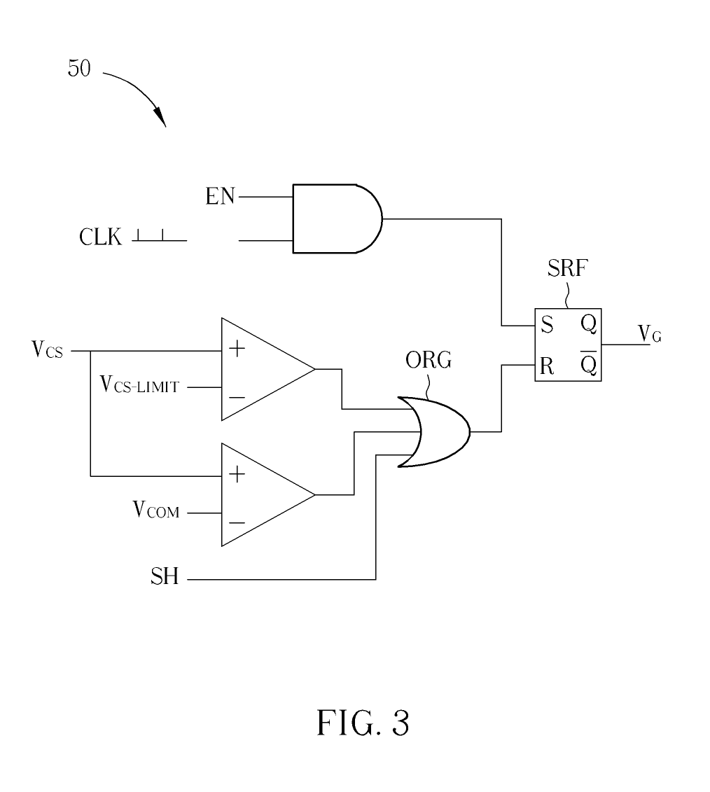

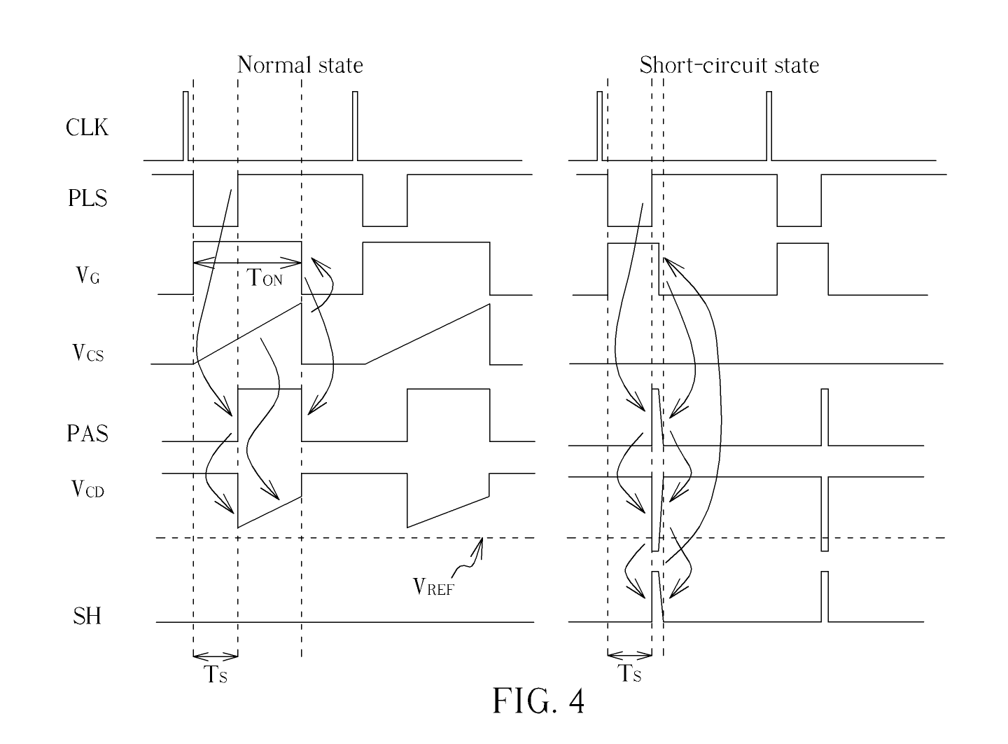

FIG. 2 illustrates controller 19 according to an embodiment of the present invention, where controller 19 can be utilized for replacing controller 18 of SMPS 10 shown in FIG. 1. FIG. 3 illustrates logic controller 50 according to an embodiment of the present invention. FIG. 4 illustrates a waveform diagram of signals shown in FIG. 2, where left-half of FIG. 4 indicates signals in a normal state, and right-half of FIG. 4 indicates signals in a short-circuit state indicating zero resistance of current detection resistor 14.

Controller 19 includes shielding time generator 42, short-circuit detector 44, logic controller 50, recorder 48, counter 46, and reference voltage generator 54.

As indicated by clock signal CLK illustrated in FIG. 4, a clock short pulse is periodically issue by clock signal CLK for indicating the beginning of a switch cycle. In shielding time generator 42 shown in FIG. 2, voltage-to-current converter 86 provides a current to charge capacitor C_{LN}. Primary winding voltage V_{IN} is detected by detecting voltage level of signal V_{LN} at terminal LN, and the current for charging capacitor C_{LN} is changed corresponding to primary winding voltage V_{IN}. Clock signal CLK periodically resets and discharges capacitor C_{LN}. Clearly, when pulse signal PLS indicates a logical zero, shielding time T_{S} will be introduced, as indicated by pulse signal PLS shown in FIG. 4, where length of shielding time T_{S} is changed corresponding to primary winding voltage V_{IN}.

In FIG. 2, signal PAS indicates a result of performing AND logic operation on gate signal V_{G} and pulse signal PLS. Therefore, when signal PAS indicates logic one, it means that power switch 16 is turned on and that a current timing of controller 18 is without shielding time T. On the other hand, when signal PAS indicates logic zero, it means that power switch 16 is turned off or that the current timing of controller 18 is during shielding time T_{S}.

Short-circuit detector 44 detects whether signal V_{CS} is lower than a predetermined voltage level when signal PAS indicates logic one. When signal PAS indicates logic one, switch 94 is short-circuited, and jammer 82 becomes a source follower or a level shifter. Therefore, intermediate signal V_{CD} is changed corresponding to detection signal V_{CS}, and intermediate signal V_{CD} is approximately higher than detection signal V_{CS} by a threshold voltage V_{THP} of a PMOS. When intermediate signal V_{CD} is lower than reference voltage V_{REF}, i.e. when detection signal V_{CS} is lower than a magnitude equal to subtracting threshold voltage V_{THP} from reference voltage V_{REF}, comparator 88 asserts short-circuit detection signal SH. When signal PAS indicates logic zero, jammer 82 jams detection signal V_{CS}, and intermediate signal V_{CD} is raised to be higher than reference voltage V_{REF} by a fixed voltage level so that short-circuit detection signal SH cannot be asserted. Reference voltage V_{REF} is required to be determined precisely to distinguish a normal state from a short-circuit state. In the normal state, and when signal PAS indicates logic one, reference voltage V_{REF} has to be low enough so that detection signal V_{CS} will not assert short-circuit detection signal SH. In the short-circuit state, and when signal PAS indicates logic one, reference voltage V_{REF} has to be high enough so that detection signal V_{CS} is capable of asserting short-circuit detection signal SH.

When short-circuit detection signal SH is asserted, logic controller 50 immediately disasserts gate signal V_{G}, and power switch 16 is turned off by driving signal V_{GATE}, which is controlled by gate signal V_{G}, through driving circuit 52. As a result, the inductive current flowing through primary winding 28 is reduced.

In a current switch cycle, if short-circuit detection signal SH is not asserted, recorder 48 will force all D flip-flops of counter 46 to reset and to output logic zero. Counter 46 may keep its value in its next switch cycle only when recorder 48 records signs of assertion of short circuit detection signal SH. After counter 46 counts three assertions of short-circuit detection signal SH, logic controller 50 is disabled to keep power switch 16 turned off, and is no longer periodically turned on corresponding to pulse signal PLS. As can be observed, combination of recorder 48 and counter 46 may be regarded as a delay logic controller which is utilized for restricting power switch 16 from turning on by disabling logic controller 50 after short-circuit detection signal SH is asserted in four consecutive switch cycles. Number of times short-circuit detection signal SH is asserted consecutively for disabling logic controller 50 may be changed in other embodiments of the present invention. When signal UVLO-reset indicates logic one, recorder 48 and counter 46 can be simultaneously reset so that recorder 48 restarts recording and counter 46 restarts counting, where signal UVLO-reset indicates a reset signal for under-voltage lockout (UVLO). Recorder 48 and counter 46 shown in FIG. 2 may be replaced by other elements having same functions in other embodiments of the present invention.

In FIG. 3, with the aid of OR-logic gate ORG and S-R flip-flop SRF, power switch 16 can be turned off immediately as long as any of the following three conditions occurs. A first condition indicates that detection signal V_{CS} is higher than current-limiting voltage V_{CS-LIMIT} a second condition indicates that detection signal V_{CS} is higher than compensation signal V_{com,} and a third condition indicates that short-circuit detection signal SH is asserted. Compensation signal V_{com} roughly indicates a required power of load 30. When logic controller 50 is enabled, i.e. when terminal EN stays at logic one, gate signal V_{G} is periodically asserted by clock signal CLK. When logic controller 50 is disabled, i.e. when terminal EN stays at logic zero, clock signal CLK is blocked so that gate signal V_{G} cannot be asserted.

Please refer to the left part of waveform diagram shown in FIG. 4 for indicating a normal state. Clock signal CLK periodically issues a short pulse. Each occurrence of the short pulse renders pulse signal PLS to be logic zero. Shielding time T_{S}, i.e. a period of time when pulse signal PLS stays logic zero, is changed corresponding to primary winding voltage V_{IN}. Each occurrence of the short pulse also asserts gate signal V_{G} so that detection signal V_{CS} is raised along with time. During shielding time T_{S}, signal PAS stays at logic zero so that intermediate signal V_{CD} is pulled to a fixed voltage level. After expiration of shielding time T_{S}, if gate signal V_{G} is still asserted, signal PAS is transited to logic one so that intermediate signal V_{CD} follows detection signal V_{CS}. When detection signal V_{CS} is higher than current-limiting reference voltage V_{CS-LIMIT} or compensation signal V_{COM}, gate signal V_{G} is disasserted so that signal PAS is transited to logic zero and intermediate signal V_{CD} is returned to the fixed voltage level . As can be observed from waveform of intermediate signal V_{CD} , since intermediate signal V_{CD} is kept higher than reference voltage V_{REF}, short-circuit detection signal SH is kept disasserted.

Please refer to the right part of waveform diagram shown in FIG. 4 for indicating a short-circuit state. Since current detection resistor 14 has zero resistance, detection signal V_{CS} is kept at zero volts, i.e. detection signal V_{CS} is not higher than current-limiting reference voltage V_{CS-LIMIT} or compensation signal V_{COM}, so that gate signal V_{G} cannot be disasserted during shielding time T_{S}. After expiration of shielding time T_{S}, signal PAS is transited to logic one so that intermediate signal V_{CD} follows detection signal V_{CS}. At this time, since detection signal V_{CS} is roughly kept at zero volts, intermediate signal V_{CD} will be lower than reference voltage _{VREF;} as a result, short-circuit detection signal SH is asserted, gate signal V_{G} is disasserted, and power switch 16 is thereby turned off. Disasserted gate signal V_{G} causes signal PAS to be transited to logic zero, causes intermediate signal V_{CD} to return to the fixed voltage level, and causes short-circuit detection signal SH to be disasserted.

As can be observed from the right part of FIG. 4, if the short-circuit phenomenon occurs, i.e. when the detection signal V_{CS} is kept at zero volts, after the expiration of shielding time T_{S} of each switch cycle, short-circuit detection signal SH will be briefly asserted once. Each time short-circuit detection signal SH is asserted, gate signal V_{G} is disasserted immediately after a short period of signal delay, thereby preventing trouble caused by overlong occurrence of gate signal V_{G} in each switch cycle, where said overlong occurrence of gate signal V_{G} is caused by the short-circuit phenomenon.

If short-circuit detection signal SH is asserted in four consecutive switch cycles, logic controller 50 is disabled until signal UVLO-reset is changed to logic one. After signal UVLO-reset is changed to logic one, logic controller 50 is periodically turned on corresponding to pulse signal PLS. When signal UVLO-reset indicates logic one, it also indicates an over-low voltage of an operational power source of controller 19.

Shielding time T_{S} is decreased with increase of primary winding voltage V_{IN}. For example, when primary winding voltage V_{IN} is at three hundred volts, shielding time T_{S} is equal to a quarter of switch cycle T; when primary winding voltage V_{IN} is at one hundred volts, shielding time T_{S} is equal to a half of switch cycle T. In another embodiment of the present invention, shielding time T_{S} may not be varied corresponding to primary winding voltage V_{IN}.

By detecting gate signal V_{G}, reference voltage generator 54 generates reference voltage V_{REF} according to a duty ratio of power switch 16. For example, when the duty ratio is equal to 0.75, reference voltage VREF will be equal to 0.1 volts plus threshold voltage VTHP; when the duty ratio is equal to 0.25, the duty ratio will be equal to 0.3 volts plus threshold voltage VTHP. In another embodiment of the present invention, reference voltage VREF may not be varied corresponding to the duty ratio.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A protection circuit applied in a controller, the controller detecting an input signal generated by a current flowing through a detection resistor, thereby controlling a switch to adjust the current, the protection circuit comprising:
a shielding time generator for providing a shielding time;
a short-circuit detector for comparing the input signal with a first reference voltage, thereby asserting a short-circuit detection signal, wherein the short-circuit detection signal is not asserted when the switch is turned off or during the shielding time; and
a logic controller for turning off the switch to reduce the current each time the short-circuit detection signal is asserted.

2. The protection circuit of claim 1 wherein the short-circuit detector comprises:
a shielding circuit for receiving the input signal to generate an intermediate signal, wherein the intermediate signal is changed corresponding to the input signal when the switch is turned on and without the shielding time; and
a comparator for comparing the intermediate signal with a second reference signal, thereby asserting the short-circuit detection signal;
wherein the short-circuit detection signal is not asserted by the intermediate signal when the switch is turned off or during the shielding time.

3. The protection circuit of claim 1 further comprising:
a counter for restricting the switch from turning on after the short-circuit detection signal is asserted a predetermined number of times.

4. The protection circuit of claim 1 further comprising:
a delay logic controller for restricting the switch from turning on after the short-circuit detection signal is consecutively asserted for a predetermined number of switch cycles.

5. The protection circuit of claim 1 wherein the shielding time is changed corresponding to a power source voltage.

6. The protection circuit of claim 1 further comprising:
a reference voltage generator for generating the first reference voltage according to a duty ratio of the switch.

7. A protection method applied in a controller, the controller detecting an input signal generated by a current flowing through a detection resistor, thereby controlling a switch to adjust the current, the protection method comprising:
providing a shielding time;
comparing the input signal with a first reference voltage when the switch is turned on and without the shielding time, thereby asserting a short-circuit detection signal;
disasserting the short-circuit detection signal when the switch is turned off or during the shielding time; and
turning off the switch immediately each time to reduce the current if the short-circuit detection signal is asserted.

8. The protection method of claim 7 further comprising:
receiving the input signal to generate an intermediate signal, wherein the intermediate signal is changed corresponding to the input signal when the switch is turned on and without the shielding time;
comparing the intermediate signal with a second reference voltage, thereby asserting the short-circuit detection signal; and
restricting the short-circuit detection signal from being asserted by the intermediate signal when the switch is turned off or during the shielding time.

9. The protection method of claim 7 further comprising:
restricting the switch from turning on after the short-circuit detection signal is consecutively asserted for a predetermined number of switch cycles.

10. The protection method of claim 7 wherein the shielding time is changed corresponding to a power source voltage.

11. The protection method of claim 7 further comprising:
generating the first reference voltage according to a duty ratio of the switch.
